(19) United States
(12) Patent Application Publication
(10) Pub. No.: US 2026/0284705 A1
(43) Pub. Date: Sep. 24, 2026

(54) ROTATING FLAPPING-WING UNDERWATER LOW-FREQUENCY SOUND DEVICE AND CONTROL METHOD THEREOF

(71) Applicant: Hunan University of Science and Technology, Xiangtan (CN)

(72) Inventors: Yongping Jin, Qiandongnan Prefecture (CN); Shuli Liu, Luohe (CN); Buyan Wan, Changsha (CN)

(21) Appl. No.: 19/686,977

(22) Filed: May 25, 2026

(30) Foreign Application Priority Data
Feb. 12, 2026 (CN) 202610207746.2

(51) Int. Cl. B06B 1/12; B06B 1/04

(52) U.S. Cl. CPC B06B 1/12; B06B 1/04; B06B 2201/74

(57) ABSTRACT

Provided are a rotating flapping-wing underwater low-frequency sound device and a control method. The rotating flapping-wing underwater low-frequency sound device includes a bracket, a flapping-swing device, a rotating drive device, and a flapping device. The rotating drive device controls a flapping-wing to rotate, and the flapping device controls a linear reciprocating motion of the flapping-wing, the two work together to produce low-frequency sound waves by flapping water flow. Rotation and linear motion do not interfere with each other, and parameters can be independently adjusted to modulate sound waves of different frequencies.

### CROSS-REFERENCE TO RELATED APPLICATIONS

This application claims priority to Chinese Patent Application No. 202610207746.2, filed on Feb. 12, 2026, which is hereby incorporated by reference in its entirety.

### TECHNICAL FIELD

The present disclosure relates to the field of underwater sound source equipment technologies, and in particular, to a rotating flapping-wing underwater low-frequency sound device and a control method thereof.

### BACKGROUND

The research, development and utilization of the ocean cannot be separated from sound waves. Sound waves are the only information carrier that can propagate over long distances in the ocean. In recent years, the development direction of underwater sound source equipment has tended towards low frequency, high power, and small size. Underwater sound source equipment is mainly used to generate low-frequency sound waves underwater. Because underwater target radiation noise is mainly concentrated in the low-frequency frequency band, and low-frequency sound waves have the unique advantage of long propagation distance, underwater sound source equipment has important application prospects in marine research and national defense construction.

At present, the power drive of underwater sound source equipment at home and abroad mainly includes active material drive, electromagnetic drive, and explosive drive. However, the active material drive is limited by the displacement limitation of piezoelectric ceramics and rare earth magnetostrictive materials, requiring a large radiation area to achieve low-frequency high-power emission, resulting in high volume and weight of the transducer and low energy density; electromagnetic drive utilizes the interaction between electric and magnetic fields, with a radiation area that can reach millimeter level. However, due to limitations such as heat generation, losses, and inherent magnetic saturation, its output force is small and energy conversion efficiency is low; the common applications of explosive drive include air guns and plasma sources, both of which are instantaneous releases of energy in water with poor frequency controllability, rendering it difficult to form sustained strong sound waves.

### SUMMARY

In order to solve technical problems of poor frequency controllability and difficulty in high-power transmission of low-frequency sound waves in underwater sound source equipment, the present disclosure provides a rotating flapping-wing underwater low-frequency sound device and a control method thereof.

The present disclosure is implemented as follows.

In a first aspect, the present disclosure provides a rotating flapping-wing underwater low-frequency sound device.

In a second aspect, the present disclosure further provides a control method for a rotating flapping-wing underwater low-frequency sound device.

### BRIEF DESCRIPTION OF DRAWINGS

In order to provide a clearer explanation of the technical solution in the embodiments of the present disclosure, a brief introduction will be given to the accompanying drawings required for the description of the embodiments.

FIG. 1 is a three-dimensional structural schematic diagram provided by the present disclosure.

FIG. 2 is a decomposed schematic diagram of FIG. 1 provided by the present disclosure.

FIG. 3 is a sectional schematic sectional provided by the present disclosure.

FIG. 4 is an enlarged schematic diagram of part A in FIG. 3 provided by the present disclosure.

FIG. 5 is an enlarged schematic diagram of part B in FIG. 3 provided by the present disclosure.

FIG. 6 is a decomposed schematic diagram of a flapping-wing device provided by the present disclosure.

FIG. 7 is a structural schematic diagram of a connection rod provided by the present disclosure.

FIG. 8 is a structural schematic diagram of a power component provided by the present disclosure.

FIG. 9 is a structural block diagram of a control module provided by the present disclosure.

FIG. 10 is a flowchart of a control method for a rotating flapping-wing underwater low-frequency sound device provided by the present disclosure.

Numeral reference: 10—bracket, 20—flapping-swing device, 21—rotating hub, 22—installation base, 221—installation protrusion, 222—recess, 23—flapping-wing, 24—hub shaft, 25—hub bearing cylinder, 251—hub bearing, 30—rotating drive device, 31—rotating shaft, 311—shaft bearing, 32—rotor, 33—stator, 34—first protective shell, 35—shaft flange, 40—flapping device, 41—power component, 411—vibration table, 412—flapping shaft, 413—bearing sealing cylinder, 414—second protective shell, 42—conversion component, 421—main shaft, 422—bearing structure, 4221—double row tapered bearing, 4222—bearing top fastener, 4223—limit collar, 4224—protection kit, 4225—elastic member, 423—connection rod structure, 4231—flapping connection rod, 4232—shaft ear, 424—main shaft flange, 50—multi—grid cover.

### DESCRIPTION OF EMBODIMENTS

In order to further clarify the purpose, technical solution, and advantages of the present disclosure, the following will provide a detailed explanation of the present disclosure in combination with the accompanying drawings and embodiments. It should be understood that specific embodiments described herein are only used to explain the present disclosure and are not intended to limit the present disclosure.

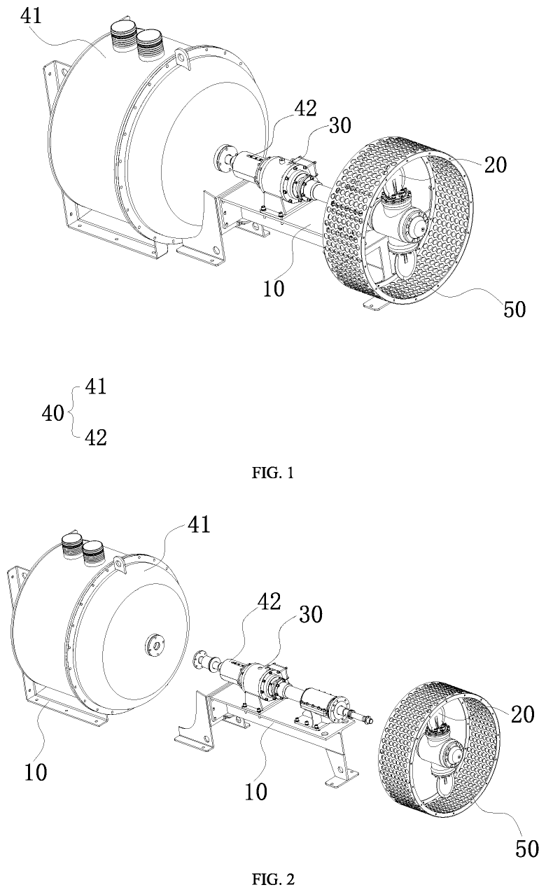

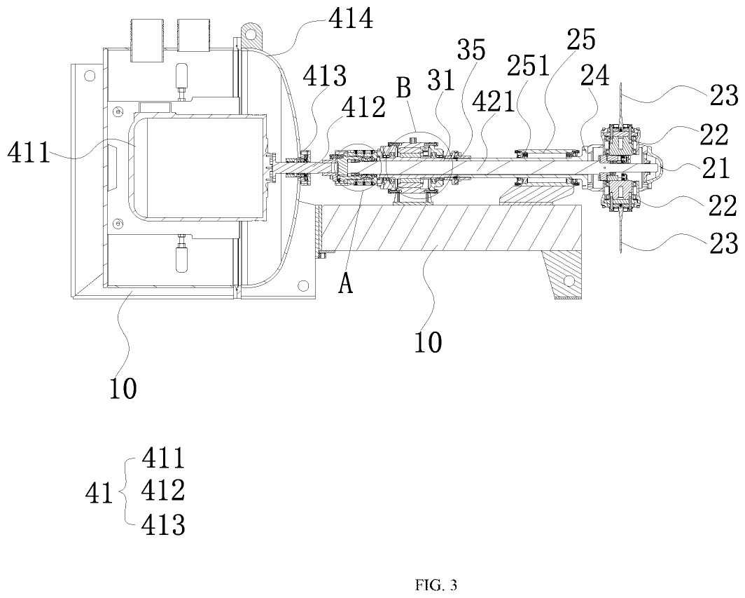

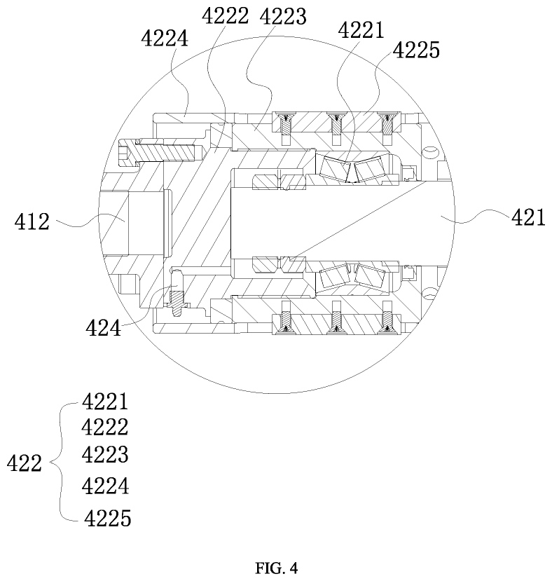

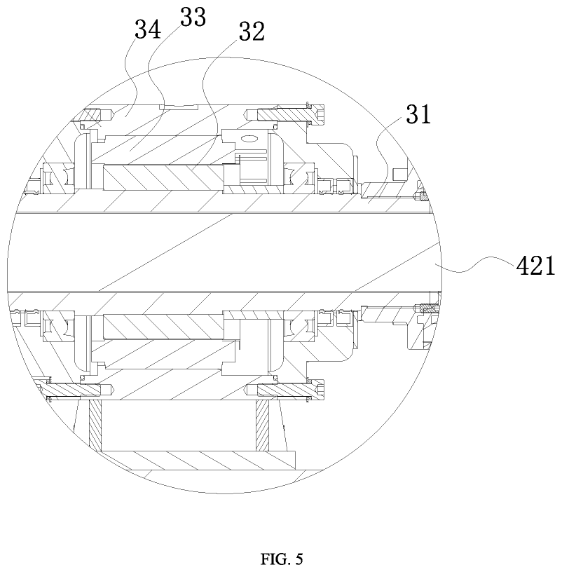

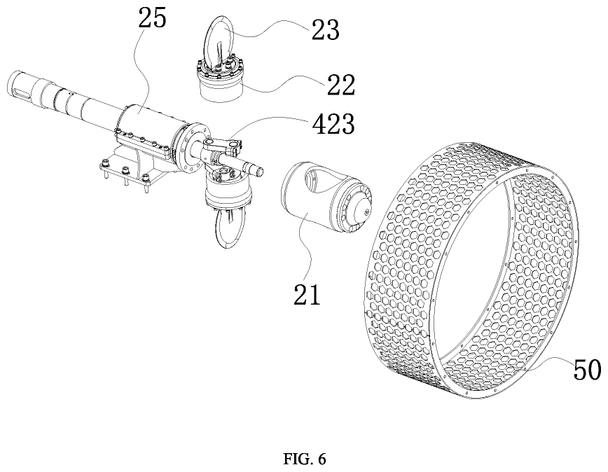

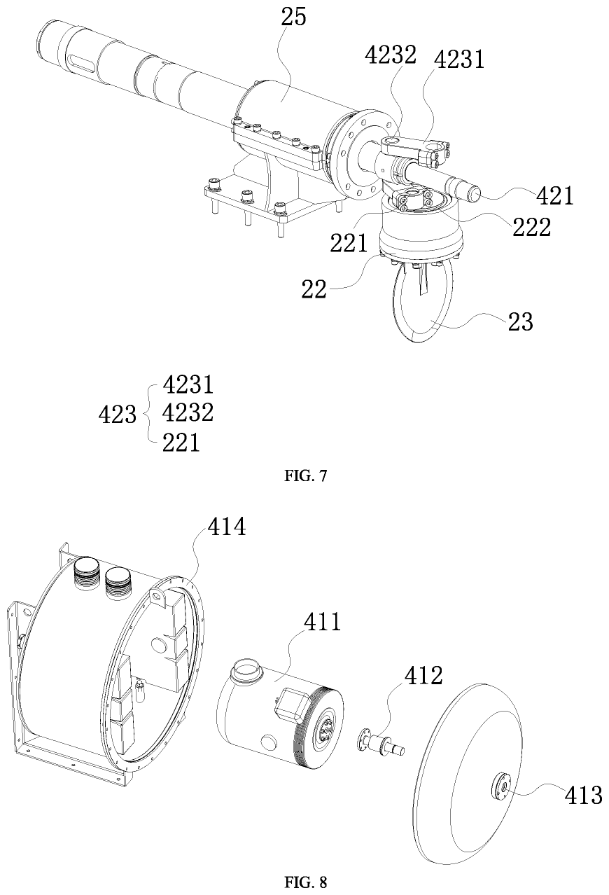

Referring to FIGS. 1-8, an embodiment of the present disclosure provides a rotating flapping-wing underwater low-frequency sound device that includes a bracket 10 and a flapping-swing device 20 for flapping water flow. The bracket 10 is provided with a rotating drive device 30 for controlling the flapping-swing device 20 to rotate, and a flapping device 40 for controlling a linear reciprocating motion of the flapping-swing device 20.

In this embodiment, when the underwater low-frequency sound device is started and operated, the rotating drive device 30 controls flapping-wings 23 to rotate. The flapping-swing device 20 controls the flapping-wings 23 to perform periodic linear reciprocating motion while the flapping-wings 23 rotate. The flapping-wings 23 flap the water flow under the coordinated driving of the rotation motion and linear reciprocating motion, thereby forming multi-directional and periodic composite disturbances in the water flow, greatly improving the energy exchange efficiency between the flapping-wings 23 and the water flow, reducing the energy loss of fluid fluctuations, and increasing the emission power of low-frequency sound waves;
at the same time, due to a non-interference between the rotational motion and linear reciprocating motion of the flapping-wings 23, low-frequency sound waves with different frequency characteristics can be modulated by independently adjusting the rotational motion parameters and linear reciprocating motion parameters of the flapping-wings 23 to adapt to different underwater application scenarios.

In an implementation mode, the flapping-swing device 20 includes a rotating hub 21, and the rotating hub 21 is provided with installation bases 22 that are symmetrically arranged, the flapping-wings 23 are provided on the installation bases 22.

In an implementation mode of the present disclosure, the rotating hub 21 is connected to a hub shaft 24, and the hub shaft 24 is sleeved with a hub bearing cylinder 25. Two ends of the hub bearing cylinder 25 are provided with hub bearings 251 for providing support for the rotational movement of the hub shaft 24.

Where, the hub shaft 24 is a hollow structure.

In this embodiment, the installation bases 22 that are symmetrically arranged on the rotating hub provide a precise and symmetrical assembly reference for the flapping-wings 23 on two sides, thereby avoiding problems such as water flow disturbance and sound wave signal distortion caused by uneven force on the flapping-wings 23 during the operation of underwater low-frequency sound device, which may affect the low-frequency sound effect.

Besides that, the hub bearing cylinder 25 are sleeved outside the hub shaft 24, and the hub bearings 251 at two ends are precisely matched with the hub shaft 24, thereby providing high-precision and low friction support for the rotational motion of the hub shaft 24, avoiding radial displacement or oscillation of the hub shaft 24 during high-speed rotation, and ensuring the smoothness and continuity of the rotational motion of the hub shaft 24; and the hub bearing cylinder 25 plays a protective role on the hub shaft 24 and the hub bearings 251, which can block the erosion of core transmission components by underwater impurities and water flow impact, ensuring the reliability of power transmission.

It should be noted that when facing different underwater environments, the above-mentioned rotating hub 21 can be replaced with different sizes, and the above-mentioned flapping-wings 23 can also be replaced with different shapes or sizes to adapt to different underwater environments.

In an implementation mode, the rotating drive device 30 includes a rotating shaft 31 connected to the hub shaft 24. The rotating shaft 31 is provided with a rotor 32 for driving a rotation of the rotating shaft 31, and an outer side of the rotor 32 is sleeved with a stator 33.

In an implementation mode, two ends of the rotating shaft 31 are provided with shaft bearings 311 that provide support for a rotation of the rotating shaft 31.

Where, the rotating shaft 31 is a hollow structure.

In this embodiment, when the underwater low-frequency sound device is in operation, the stator 33 receives the working current output from the working power supply, and generates a periodically changing magnetic field according to the principle of electromagnetic induction. The generated changing magnetic field acts on the rotor 32, causing the rotor 32 to obtain rotational torque and rotate around an axis direction. The rotational power generated by the rotor 32 is transmitted to the rotating shaft 31, driving the rotating shaft 31 to rotate synchronously. The hub shaft 24 connected to the rotating shaft 31 also rotates synchronously, thus providing a continuous and stable power source for the rotational motion of the flapping-wings 23; and, the shaft bearings 311 provided at two ends of the rotating shaft 31 will constrain the radial displacement and axial movement of the rotating shaft 31, avoiding offset, swinging or tilting during the rotation process, ensuring stable shaft speed and accurate torque transmission.

In an implementation mode, an outer side of the stator 33 is provided with a first protective shell 34.

In this embodiment, the first protective shell 34 can effectively block the erosion and damage of underwater sediment, suspended impurities, etc. to the stator 33, the rotor 32, and the rotating shaft 31, avoiding electromagnetic drive jamming and faults caused by impurities entering the clearance between the stator 33 and the rotor 32; it can also buffer the direct force of water flow impact on the stator 33, avoiding loosening or deformation of the stator structure, which affects the output of rotational driving force.

In an implementation mode, a shaft flange 35 is provided at a connection between the rotating shaft 31 and the hub shaft 24.

Due to the fact that most existing connection methods between shafts use welding or plug-in connections, problems such as cracks at the welding points or loosening of the plug-in structure are prone to occur. When facing impact loads such as vibration in underwater environments, especially in deep-sea environments, it is easy to break and loosen, resulting in the inability to effectively output low-frequency sound waves.

In this embodiment, the shaft flange forms a coaxial rigid connection structure between the rotating shaft 31 and the hub shaft 24, allowing the rotational power generated by the rotating shaft 31 to be transmitted to the hub shaft 24, achieving the rotational motion of the flapping-swing device 20; the rigid connection structure formed by the rotating shaft flange can effectively withstand the torque transmitted by the rotating shaft 31 and the impact loads such as vibration in the underwater environment, compared to traditional connection methods such as welding or plugging, and avoid failure situations such as looseness and fracture at the connection part, ensuring the continuity and reliability of power transmission, and thus ensuring the stability of the rotational motion of the flapping-swing device 20, avoiding interruption or distortion of sound wave output caused by connection failure.

In an implementation mode, the flapping device 40 includes a power component 41 and a conversion component 42, where the conversion component 42 is configured to convert the flapping force provided by the power component 41 into the power for controlling the linear reciprocating motion of the flapping-swing device 20.

In an implementation mode, the power component 41 includes a vibration table 411 that provides flapping force, and a power output side of the vibration table 411 is connected to a flapping shaft 412, and the flapping shaft 412 is provided with a flapping shaft bearing sealing cylinder 413.

Where, an outer side of the vibration table 411 is further provided with a second protective shell 414, and the second protective shell 414 is configured to prevent damage and erosion of the vibration table 411 and the flapping shaft 412 by underwater foreign objects.

It is worth noting that the above-mentioned vibration table 411 is a type of periodic vibration force that can output specific frequency and amplitude characteristics according to preset control instructions, thereby providing a stable power source for the linear reciprocating motion of the flapping-wings 23.

In this embodiment, providing the conversion component can convert the flapping force output by the vibration table 411 into the power to control the linear reciprocating motion of the flapping-swing device 20 without interfering with the rotational motion of the flapping-swing device 20, avoiding problems such as interference between linear reciprocating motion and rotational motion, power transmission chaos, etc., ensuring that the linear reciprocating motion and rotational motion of the flapping-swings are coordinated and free of motion interference, and ensuring the frequency stability and waveform uniformity of low-frequency sound wave output.

In an implementation mode, the conversion component 42 includes a main shaft 421, and the main shaft 421 sequentially passes through the rotating shaft 31 and the hub shaft 24. One end of the main shaft 421 near the flapping shaft 412 is provided with a bearing structure 422 for converting flapping force into linear reciprocating flapping force, and the other end of the main shaft 421 is provided with a connection rod structure 423 for controlling the linear reciprocating motion of the flapping-wing 23.

In an implementation mode, the bearing structure 422 includes a double row tapered bearing 4221 arranged on the main shaft 421, and the double row tapered bearing 4221 is configured to withstand the bidirectional axial and radial forces when the main shaft 421 reciprocates along an axis direction. One end of the main shaft 421 is provided with a bearing top fastener 4222 for driving a movement of the double row tapered bearing 4221. The double row tapered bearing 4221 is provided with a limit collar 4223 connected to the bearing top fastener 4222, and the limit collar 4223 is configured to limit a movement freedom of the double row tapered bearing 4221. An outer side of the limit collar 4223 is further provided with a protective kit 4224, and the protective kit 4224 is provided with an elastic member 4225. The elastic member 4225 is configured to adjust the limitation degree of the limit collar 4223 on the double row tapered bearing 4221.

Where the double row tapered bearing is a back-to-back combination of two single row bearings.

In an implementation mode, the periodic vibration force output by the vibration table 411 will be driven by the flapping shaft 412 to synchronize the linear reciprocating motion of the bearing top fastener 4222, and then drive the main shaft 421 to perform linear reciprocating motion along the axis direction. During the movement of the main shaft 421, the double row tapered bearing 4221 bears the bidirectional axial force and radial force when the main shaft 421 reciprocates along the axis direction, thereby avoiding local stress concentration that may cause component deformation or power transmission jamming during the movement of the main shaft 421. At the same time, the tightness of the limit collar 4223 is adjusted by the elastic member 4225 provided on the protective kit 4224, and a clamping force of the double row tapered bearing 4221 is adjusted through the limit collar 4223 to limit the movement freedom of the double row tapered bearing 4221 so as to ensure that the motion of the main shaft 421 is linear to avoid mechanical wear or power transmission lag caused by rotation or deflection.

In this embodiment, the double row tapered bearing adopts a back-to-back combination structure of two single row bearings, and its contact position is symmetrically arranged to simultaneously withstand a bidirectional axial force (i.e. a bidirectional force during the main shaft pushing and pulling process) and a radial force (i.e. an offset force perpendicular to an axis caused by assembly deviation or water flow disturbance during the main shaft pushing and pulling process) generated by the reciprocating motion of the main shaft along the axis direction, thereby evenly dispersing the composite force to the two single row bearings, thereby achieving multi-directional force balanced bearing, and effectively avoiding component deformation or power transmission jamming caused by local stress concentration.

In an implementation mode, the connection rod structure 423 includes a flapping connection rod 4231, one end of the flapping connection rod 4231 is connected to a shaft ear 4232 fixed on the main shaft 421, and the other end of the flapping connection rod 4231 is connected to an installation protrusion 221 fixed on the installation bases 22. The installation bases 22 further have a recess 222 configured for the flapping connection rod 4231 to perform linear reciprocating motion.

In this embodiment, when the main shaft 421 performs linear reciprocating motion, the shaft ear 4232 drives the flapping connection rod 4231 to synchronously perform linear reciprocating motion. The other end of the flapping connection rod 4231 transmits the power of linear reciprocating motion to the installation bases 22 through the installation protrusion 221. The recess 222 on the installation bases 22 allows the flapping connection rod 4231 to only perform linear reciprocating motion along the recess 222, effectively limiting the displacement of the flapping connection rod 4231 during the motion process, thereby driving the flapping-wing 23 to perform linear reciprocating motion.

In an implementation mode, a main shaft flange 424 is provided at a connection between the flapping shaft 412 and the main shaft 421.

In this embodiment, the main shaft flange forms a coaxial rigid connection structure between the main shaft and the flapping shaft, allowing the linear reciprocating motion force of the flapping shaft to be transmitted to the main shaft, achieving the linear reciprocating motion of the flapping-wings 23.

In an implementation mode, an outer periphery of the flapping-swing device 20 is provided with a multi-grid cover 50, and the multi-grid cover 50 is a uniformly hollow grid structure.

Due to the presence of sediment, suspended impurities, small marine organisms, and floating objects in the underwater environment, these underwater objects can easily collide with the high-speed rotating and linear reciprocating motion of flapping-wings 23, causing deformation and fracture of the wings. They can also easily entangle the connection rod structure, resulting in damage to the connection rod structure and power transmission lag.

In this embodiment, the multi-grid cover 50 provided in this embodiment surrounds the flapping-wings 23, thereby forming a protective barrier through its uniformly hollowed out grid structure. On the one hand, it can effectively block large underwater foreign objects from entering an inner flapping-wing movement area, thereby avoiding collisions with high-speed flapping-wings 23 or entanglement on the connection rod structure, causing component damage and affecting the emission of low-frequency underwater sound waves; on the other hand, a uniformly distributed grid structure can rectify and guide the water flow entering the flapping motion area, allowing the water flow to smoothly flow through the flapping-wings 23 in a predetermined direction, reducing the interference of disordered water flow on the flapping-wings flapping water flow, and ensuring the stable frequency, uniform amplitude, and low distortion of the generated low-frequency sound waves.

In an implementation mode, in order to accurately and independently control the composite motion of the flapping-wings 23 and achieve intelligent operation, the rotating flapping-wing type underwater low-frequency sound device of the present disclosure further includes a control module. The control module is integrated inside the device or connected through wired/wireless means, and the control module includes a voltage conversion module, a main control module, a rotation drive module, and a flapping drive module. The voltage conversion module is responsible for converting a single external input power source into multiple stable Direct Current, (DC) power sources with different voltage levels, providing suitable power supply for various electrical components in the system. The main control module serves as a control center and establishes communication links with the rotating drive module and flapping drive module through independent communication ports I and II, respectively. A user can input control instructions and parameters through the upper computer or human-machine interface. After receiving them, the main control module sends the rotation motion control parameters (such as speed and steering) to the rotating drive module through two independent communication links that do not interfere with each other, and sends the flapping motion control parameters (such as flapping frequency and amplitude) to the flapping drive module. The rotating drive module drives the stator 33 inside the rotating drive device 30 to work according to instructions, thereby precisely regulating the rotational motion of the flapping-wings 23; the flapping drive module drives the vibration table 411 inside the flapping device 40 according to the instructions, thereby independently regulating the linear reciprocating motion of the flapping-wings 23. This dual channel independent control architecture ensures the complete decoupling of rotational motion and flapping motion in terms of power source and control logic, achieving independent, precise, and continuously adjustable two motion parameters (such as rotational frequency and flapping frequency), thus synthesizing a rich and diverse composite sound wave signal with frequency characteristics, greatly enhancing the adaptability and control flexibility of the device to different underwater application scenarios (such as communication at different distances and detection of different targets).

In an implementation mode, the control module also has real-time monitoring and self-diagnostic functions for system operation state. After the device is powered on, the main control module automatically executes the system initialization and self-check program, verifies whether the communication links with the rotation drive module and the flapping drive module are normal, and reads the initial state of each sensor to ensure that the system is in a ready state. During the operation of the device, the rotating drive module collects real-time operating parameters of the rotating drive device 30, such as motor speed, working current, and winding temperature. The flapping drive module collects real-time operating parameters of the flapping device 40, such as the flapping frequency, actual displacement, and driving current of the vibration table 411, and sends the above parameters back to the main control module in real time through their respective communication links. The main control module processes and fuses the received data, and can visually display key wave-forms such as “speed time”, “flapping displacement-time”, “current-time” in the form of numbers, instrument panels, or real-time data curves on the connected display interface, allowing the user to directly and accurately monitor the real-time working state and load conditions of the device. This closed-loop monitoring mechanism not only facilitates timely detection of abnormalities such as overload and jamming by operators but also provides a data foundation for adaptive control and fault warning of devices.

In an implementation mode, the control module is integrated with a data storage unit for recording and subsequent playback analysis of system operating data, which is crucial for the study of sound source characteristics and device optimization. All monitored real-time operating parameters and user set motion parameters can be synchronously stored. The operating condition parameters include two types: one is motion parameters, namely rotational motion parameters and flapping-wing reciprocating flapping motion parameters, such as flapping frequency and amplitude; a second is geometric parameters, which refer to physical parameters of the replaceable rotating hub 21 and flapping-wings 23, such as hub diameter, flapping-wing size, shape, installation quantity, and angle of attack. By systematically changing and recording these combinations of operating condition parameters, while recording the acoustic signals output by the device, a detailed database of “operating condition—sound source characteristics” can be constructed. Researchers can use this to analyze in depth the impact of different combinations of rotation speed and flapping frequency on the output sound spectrum, sound source level, and directionality. They can also evaluate the hydrodynamic efficiency and acoustic radiation efficiency of flapping-wings 23 with different geometric shapes under different motion modes. This feature greatly facilitates the research and development process of finding the optimal device configuration and motion parameter combination for specific application goals, reflecting the high research ability and engineering application value of the device of the present disclosure.

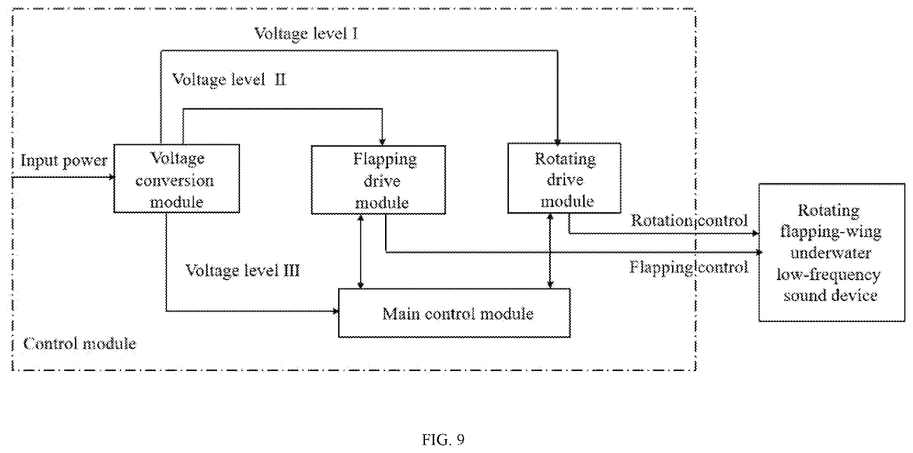

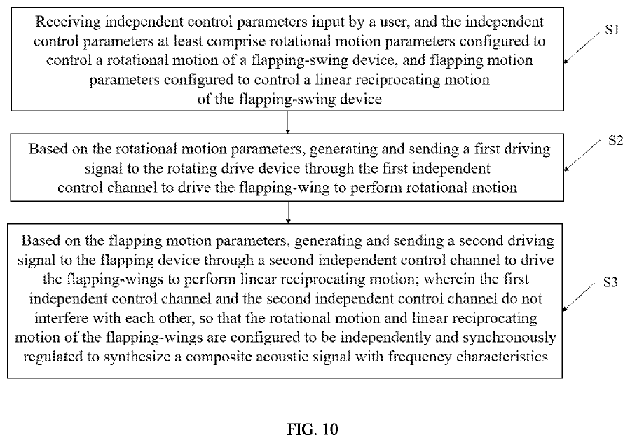

Referring to FIGS. 9 and 10, an embodiment of the present disclosure further provides a control method for a rotating flapping-wing underwater low-frequency sound device, including the following steps:
S1: receiving independent control parameters input by a user, and the independent control parameters at least include rotational motion parameters configured for controlling a rotational motion of a flapping-swing device 20, and flapping motion parameters for controlling a linear reciprocating motion of the flapping-swing device 20;
S2: based on the rotational motion parameters, generating and sending a first driving signal to a rotating drive device through a first independent control channel to drive flapping-wings 23 to perform rotational motion;
S3: based on the flapping motion parameters, generating and sending a second driving signal to the flapping device 40 through a second independent control channel to drive the flapping-wings 23 to perform linear reciprocating motion;
where the first independent control channel and the second independent control channel do not interfere with each other, so that the rotational motion and linear reciprocating motion of the flapping-wings 23 can be independently and synchronously regulated to synthesize composite acoustic signals with specific frequency characteristics.

In this embodiment, the control method aims to achieve precise and intelligent control of a rotating flapping-wing underwater low-frequency sound device. Where the control method is based on a control module execution, and the control module includes a main control module, a rotating drive module, and a flapping drive module. After the device is powered on, the main control module first performs system initialization and self-check steps: verifies whether the communication links (such as communication ports I and II) between it and the rotating drive module and the flapping drive module are normal, and reads the initial state data of each sensor (such as temperature and position sensors) to ensure that the entire control system is in a ready state for normal operation. The voltage conversion module provides suitable and stable power supply for each module.

In an implementation mode, referring to FIGS. 9 and 10, the user inputs the desired motion control parameters through the upper computer software or device human-machine interface. These parameters are sent as “independent control parameters” to the main control module. The independent control parameters are clearly divided into two categories: one is rotational motion parameters, such as target speed and rotation direction (clockwise/counterclockwise); another one is the flapping motion parameters, such as target flapping frequency, flapping amplitude (or displacement). The main control module receives and parses these parameters to prepare for generating driver instructions.

In an implementation mode, referring to FIGS. 9 and 10, the main control module adopts dual channel independent control logic. In the first independent control channel, the main control module generates corresponding first driving instructions based on the parsed rotational motion parameters (such as target speed), such as Pulse width modulation, (PWM) waves of specific frequency and voltage, and sends them to the rotating drive module through an independent communication link (such as communication port I). After receiving instructions, the rotating drive module drives the stator 33 in the rotating drive device 30 to work, thereby precisely controlling the flapping-wings 23 to rotate at the set speed and direction. In the second independent control channel, the main control module synchronously generates corresponding second driving instructions based on the analyzed flapping motion parameters, such as target flapping frequency and amplitude, and sends them to the flapping drive module through another independent communication link, such as communication port II. After receiving the instruction, the flapping drive module drives the vibration table 411 in the flapping device 40 to work, thereby independently controlling the flapping-wings 23 to perform linear reciprocating motion at the set frequency and amplitude. The key is that these two control channels are decoupled and non-interference in signal generation, transmission, and execution. This allows the rotation speed and flapping frequency to be adjusted independently and continuously without coupling or interfering with each other. The operator can freely combine different rotation speeds and flapping frequency parameters to enable the flapping-wings 23 to strike the water flow under composite motion, thereby synthesizing a composite low-frequency sound wave signal with rich frequency components and adjustable characteristics to meet differentiated requirements of sound source characteristics in different scenarios such as underwater communication and detection.

In an implementation mode, the method further includes real-time monitoring and feedback steps during device operation. The rotating drive module real-time collects the operating state parameters of the rotating drive device 30, such as the actual speed, working current, and winding temperature of the motor. The flapping drive module real-time collects the operating state parameters of the flapping device 40, such as the actual flapping frequency, displacement feedback signal, and driving current of the vibration table 411. These real-time parameters are transmitted back to the main control module through their respective communication links. Where, the main control module processes and fuses the received data, and converts it into visual monitoring information. For example, the “speed-time curve”, “flapping displacement-time curve”, “current-time curve”, etc. can be dynamically displayed in the form of numbers, instrument panels, or real-time data curves on the upper computer interface. This real-time monitoring mechanism enables operators to intuitively grasp the working state and load of the device, timely detect abnormal situations such as overload and jamming, and provide data basis for potential fault warning and adaptive control.

In an implementation mode, the control method further includes data storage and analysis steps. The data storage unit within the control module will synchronously record two types of key data: one is the “motion parameters” set by all users mentioned above (i.e. rotation motion parameters and flapping motion parameters); the second is the “real-time operating parameters” monitored during device operation (i.e. various state data returned as mentioned above). Besides that, it is possible to associate and record the “geometric parameters” of the current device configuration, such as the size of the installed rotating hub 21, the shape, area, and installation quantity of the flapping-wings 23, which are replaceable physical component parameters. By systematically changing the combination of motion parameters and geometric parameters and running the device, while recording the acoustic signals output by the device, a complete “working condition-sound source characteristic” relational database can be constructed. This feature enables researchers to replay and analyze the impact of different parameter combinations (such as different “rotation frequency flapping frequency” pairs) on the final generated sound spectrum, sound source level, and directionality based on historical data, or evaluate the hydrodynamic and acoustic radiation efficiency of different flapping-wing geometries. This greatly facilitates the research and development process of optimizing device parameters to achieve specific acoustic performance goals, such as maximizing sound power in specific frequency bands.

Those skilled in the art should understand that the above description is an embodiment provided in combination with specific content, and do not consider the specific implementation of the present disclosure to be limited to these descriptions. At the same time, due to different industry names, it is not limited to the above names, nor is it limited to English names. Any approximation or similarity to the method, structure, etc. of the present disclosure, or any technical deduction or substitution made under the premises of the inventive concept, should be considered as the protection scope of the present disclosure.

What is claimed is:

1. A rotating flapping-wing underwater low-frequency sound device, comprising: a bracket and a flapping-wing device configured to flap water flow, wherein the bracket is provided with a rotating drive device configured to control the flapping-wing device to rotate and a flapping device configured to control a linear reciprocating motion of the flapping-wing device;
the flapping device comprises a vibration table that provides flapping force, and a power output side of the vibration table is connected to a flapping shaft;
the flapping device further comprises a conversion component, and the conversion component comprises a main shaft that sequentially passes through the rotating drive device and the hub shaft; one end of the main shaft near the flapping shaft is provided with a bearing structure configured to convert the flapping force into linear reciprocating flapping force, and the other end of the main shaft is provided with a connection rod structure configured to control the linear reciprocating motion of the flapping-wing.

2. The rotating flapping-wing underwater low-frequency sound device according to claim 1, wherein the flapping-wing device comprises a rotating hub, and the rotating hub is provided with installation bases that are symmetrically arranged, and flapping-wings are provided on the installation bases.

3. The rotating flapping-wing underwater low-frequency sound device according to claim 2, wherein the rotating hub is connected to a hub shaft, and a hub bearing cylinder is sleeved on the hub shaft; two ends of the hub bearing cylinder are provided with hub bearings for providing support for the rotational motion of the hub shaft.

4. The rotating flapping-wing underwater low-frequency sound device according to claim 3, wherein the rotating drive device comprises a rotating shaft connected to the hub shaft, and the rotating shaft is provided with a rotor configured to drive the rotating shaft to rotate; an outer side of the rotor is sleeved with a stator, and an outer side of the stator is provided with a first protective shell.

5. The rotating flapping-wing underwater low-frequency sound device according to claim 4, wherein a shaft flange is provided at a connection between the rotating shaft and the hub shaft.

6. The rotating flapping-wing underwater low-frequency sound device according to claim 4, wherein the flapping device comprises a power component and the conversion component, wherein the conversion component is configured to convert the flapping force provided by the power component into a power configured to control the linear reciprocating motion of the flapping-swing device.

7. The rotating flapping-wing underwater low-frequency sound device according to claim 6, wherein the power component comprises the vibration table that provides flapping force, the power output side of the vibration table is connected to the flapping shaft, and the flapping shaft is provided with a flapping shaft bearing sealing cylinder.

8. The rotating flapping-wing underwater low-frequency sound device according to claim 2, wherein the bearing structure comprises a double row tapered bearing arranged on the main shaft, and the double row tapered bearing is configured to withstand bidirectional axial force and radial force when the main shaft reciprocates along an axis direction;
one end of the main shaft is provided with a bearing top fastener configured to drive the double row tapered bearing to move; the double row tapered bearing is provided with a limit collar connected to the bearing top fastener, and the limit collar is configured to limit a movement freedom of the double row tapered bearing;
an outer side of the limit collar is further provided with a protective kit, and the protective kit is provided with an elastic member configured to adjust a limitation degree of the limit collar on the double row tapered bearing;
the connection rod structure comprises a flapping connection rod, one end of the flapping connection rod is connected to a shaft ear fixed on the main shaft, and the other end of the flapping connection rod is connected to an installation protrusion fixed on the installation bases; the installation bases further have a recess configured for the flapping connection rod to perform linear reciprocating motion.

9. A control method for a rotating flapping-wing underwater low-frequency sound device, which comprises the following steps:
S1: receiving independent control parameters input by a user, and the independent control parameters at least comprise rotational motion parameters configured to control a rotational motion of a flapping-swing device, and flapping motion parameters configured to control a linear reciprocating motion of the flapping-swing device;
S2: based on the rotational motion parameters, generating and sending a first driving signal to the rotating drive device through the first independent control channel to drive the flapping-wing to perform rotational motion;
S3: based on the flapping motion parameters, generating and sending a second driving signal to the flapping device through a second independent control channel to drive the flapping-wings to perform linear reciprocating motion;
wherein the first independent control channel and the second independent control channel do not interfere with each other, so that the rotational motion and linear reciprocating motion of the flapping-wings are configured to be independently and synchronously regulated to synthesize a composite acoustic signal with frequency characteristics.
